(19) United States
(12) Patent Application Publication
(10) Pub. No.: US 2011/0270624 A1
(43) Pub. Date: Nov. 3, 2011

(54) Methods and Apparatus of an Outpatient Care System

(75) Inventor: JUN LIU, Vienna, VA (US)

(73) Assignee: JUN LIU, Vienna, VA (US)

(21) Appl. No.: 13/098,477

(22) Filed: May 1, 2011

Related U.S. Application Data
(60) Provisional application No. 61/329,566, filed on Apr. 30, 2010.

(51) Int. Cl. G06Q 50/00; G06Q 90/00

(52) U.S. Cl. 705/2; 235/375

(57) ABSTRACT

The outpatient care system comprises: outpatient medication is tagged by barcode or RFID, a reader consists of a scanning module and a wireless module, a server records medication instructions and compliances for outpatient. The system set-up comprises: doctor writes prescription to an outpatient, the outpatient presents the prescription to a pharmacy, a pharmacist prepares and tags the medication, and enter associated instructions into the server. The system operation comprises: the outpatient uses the reader to scan tagged medication when taking the medication, the reader sends scanned results to the server, the server performs compliance checking and issues a compliance report to the reader.

### RELATED APPLICATIONS INFORMATION

The application claims the benefit under 35 U.S.C. 119(e) of U.S. Provisional Patent Application Ser. No. 61/329,566, filed Apr. 30, 2010 and entitled “Methods and Apparatus of an Outpatient Care System,” which is incorporated herein by reference in its entirety.

### BACKGROUND

In medical treatments, if outpatients, for example discharged patients from hospitals, do not follow its medication instructions such as not taking medication in time, their health conditions will deteriorate. On the other hand, doctors do not have a way to know how much their outpatients comply with their respective prescriptions. Their exists a need to have an outpatient care system which can assist outpatients to follow their medication instructions, and inform doctors how medication has been used by outpatients.

### SUMMARY

Methods and apparatus of an outpatient care system are described herein.

The outpatient care system comprises: outpatient medication is tagged by barcode or RFID, a reader consists of a scanning module and a wireless module, a server records medication instructions and compliances for outpatient. The system set-up comprises: doctor writes prescription to an outpatient, the outpatient presents the prescription to pharmacy, a pharmacist prepares and tags the medication, and enter associated instructions into the server. The system operation comprises: the outpatient uses the reader to scan tagged medication when taking the medication, the reader sends scanned results to the server, the server performs compliance checking and issues a compliance report to the reader.

### BRIEF DESCRIPTION OF THE DRAWINGS

Features, aspects, and embodiments are described in conjunction with the attached drawings, in which:

FIG. 1 is a diagram illustrating a tagged medication configured in accordance with the present invention.

FIG. 2 is a diagram illustrating a reader configured in accordance with the present invention.

FIG. 3 is a diagram illustrating a system set-up configured in accordance with the present invention.

FIG. 4 is a diagram illustrating the block diagram of a system operation configured in accordance with the present invention.

FIG. 5 is a diagram illustrating the flow chart of a system operation configured in accordance with the present invention.

### DETAILED DESCRIPTION

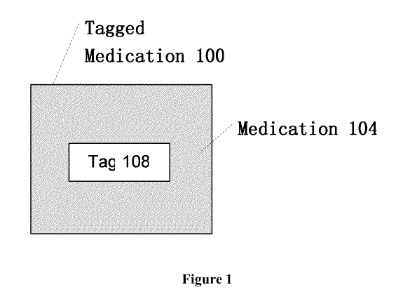

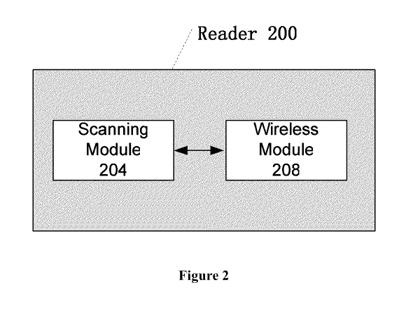

An outpatient care system is presented herein. Two basic elements in the system are tagged medication and reader to scan the tagged medication. As shown in FIG. 1, Tagged Medication 100 is the outpatient medication which is tagged by using, for example, barcode or RFID. As shown in FIG. 2, Reader 200 consists of a Scanning Module 204 and a Wireless Module 208. The Scanning module 204 is used to scan or read the tag on medication. The Scanning module 204 may be a barcode reader module or a RFID reader module. The Wireless Module 208 is used to transmit scanned results to a server and receive information from the server. The Wireless Module 208 is Wi-Fi or cellular (such as GSM, CDMA, UMTS, or Wi-MAX). The wireless data format through the Wireless Module 208 is SMS (Short Message Service) or packet data. Reader 200 may be a cellular phone with a scanning module integrated.

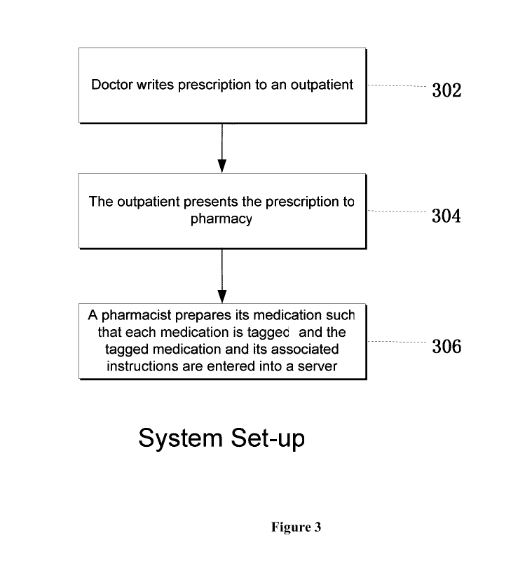

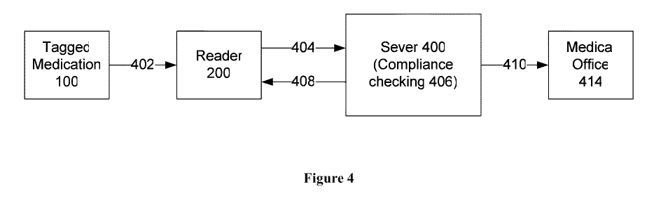

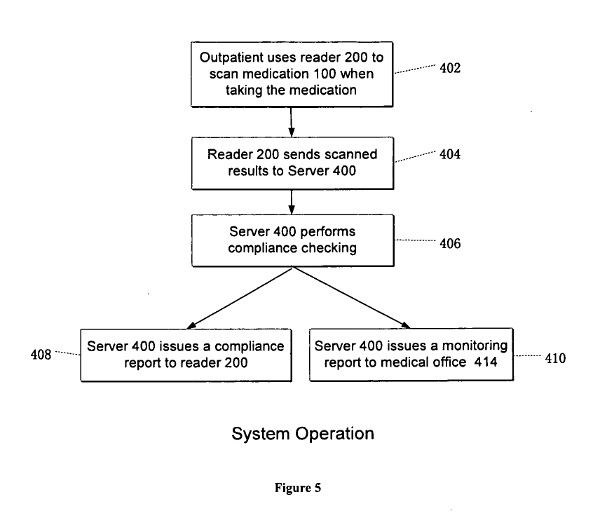

The system described herein consists of system set-up and system operation. The flow chart of system set-up is shown in FIG. 3. The block diagram of the outpatient care system is shown in FIG. 4 and the flow chart of system operation is shown in FIG. 5.

For system set-up, as shown in FIG. 3, doctor writes prescription to an outpatient at Step 302, the outpatient presents the prescriptions to pharmacy at Step 304, a pharmacist prepares the medication at Step 306 such that each medication is tagged, and the tagged medication and its associated instructions are entered into a server. Associated instructions consist of at least one of the following information: when to take, how many to take, and how often to take.

For system operation, as shown in FIG. 4 and FIG. 5, an outpatient has a reader 200, and uses it to scan or read tagged medication 100 when taking the medication at Step 402. Reader 200 sends scanned results via its Wireless Module 208 to a Server 400 at Step 404. Server 400 performs compliance checking at Step 406 by comparing with the information that was entered at system set-up. At Step 408, Server 400 issues a compliance report wirelessly to reader 200. The compliance report consists of at least one of the following information for the outpatient: medication is taken in time or not, medication is taken in correct quantity or not, medication is taken in correct time intervals or not.

In the case that reader 200 is not used at the time medication should be taken, the compliance report shall contain reminders. Additionally, the compliance report consists of new medicine information or latest medical news. In such, this system assists outpatients to follow their medication instructions. If compliance is not met, Server 400 issues a monitoring report at Step 410 via a wireless or wired connection to medical office 414. The monitoring report consists of at least one of the following information for the outpatient: medication is not taken in time, medication is not taken in correct quantity, medication is not taken in correct time intervals.

Additionally, the monitoring report consists of new medicine information or latest medical news. In such, this system informs medical staff at Medical Office 414 how medication has been used by outpatients.

Although FIGS. 3, 4 and 5 show the steps in an order that is most logical, these steps may be combined or the order changed.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

What is claimed is:

1. An outpatient care system, comprising:
outpatient medication is tagged by barcode or RFID,
a reader consists of a scanning module and a wireless module,
a server records medication instructions and compliances for outpatient.

2. The system of claim 1 wherein the outpatient uses the scanning module of the reader to read barcode or RFID on its tagged medication.

3. The system of claim 1 wherein the wireless module is for transmitting scanned results to the server and for receiving information from the server.

4. The system of claim 1 wherein the wireless module is one of the following: Wi-Fi, GSM, CDMA, UMTS and Wi-MAX.

5. The system of claim 4 wherein the wireless data format is one of the following: short messages or packet data.

6. The system of claim 1 wherein the system set-up comprises:
doctor writes prescription to an outpatient,
the outpatient presents the prescription to pharmacy,
a pharmacist prepares and tags the medication, and enter associated instructions into the server.

7. The system of claim 6 wherein associated instructions consist of at least one of the following information: when to take, how many to take, and how often to take.

8. The system of claim 1 wherein the system operation comprises:
the outpatient uses the reader to scan tagged medication when taking the medication,
the reader sends scanned results to the server,
the server performs compliance checking and issues a compliance report to the reader.

9. The system of claim 8 wherein the compliance report comprises at least one of the following information: medication is taken in time or not, medication is taken in correct quantity or not, and medication is taken in correct time intervals or not.

10. The system of claim 8 wherein the compliance report contains reminders when the reader is not used at the time medication should be taken.

11. The system of claim 8 wherein a monitoring report is issued to a medical office when medication compliance is not met.

12. The system of claim 11 wherein the monitoring report comprises at least one of the following information: medication is not taken in time, medication is not taken in correct quantity, and medication is not taken in correct time intervals.
